(19) United States
(12) Patent Application Publication
(10) Pub. No.: US 2007/0098988 A1
(43) Pub. Date: May 3, 2007

(54) Method of preparing biocompatible silicon nanoparticles

(76) Inventors: Woon Jo Cho, Uijeongbu-si (KR); Soojin Lee, Paju-si (KR); Il Ki Han, Seoul (KR); Won Jun Choi, Seoul (KR); Jung Il Lee, Seoul (KR); Jae Gwan Park, Seoul (KR)

Correspondence Address: JONES DAY, 222 EAST 41ST ST, NEW YORK, NY, 10017, US

(21) Appl. No.: 11/588,621

(22) Filed: Oct. 27, 2006

(30) Foreign Application Priority Data
Oct. 28, 2005 (KR) 10-2005-102333

(51) Int. Cl. B32B 1/00

(52) U.S. Cl. 428/403; 423/348

(57) ABSTRACT

There is provided a method of preparing biocompatible silicon nanoparticles, which comprises the steps of forming a silicon nanoparticle colloid by ultrasonic treatment of Si-containing Zintl salt in diethylene glycol diethyl ether (DGDE), and introducing hydroxyl groups into the surface of the silicon nanoparticle by treating the silicon nanoparticle colloid with a halogenated hydrogen solution. The method of the present invention can easily mass-produce silicon nanoparticles having high dispersion stability in an aqueous solution and biocompatibility in a high yield.

### FIELD OF THE INVENTION

The present invention generally relates to a method of preparing biocompatible silicon nanoparticles, and more particularly to a method of facilitating the preparation of high yields of silicon nanoparticles having a superior dispersion stability in an aqueous solution through introducing polar groups into the surface thereof and high biocompatibility due to the absence of biomolecule-degrading elements.

### BACKGROUND OF THE INVENTION

Nanobio-technology plays an important role in nano-technology. The objective of nanobio-technology is to develop mechanical devices or tools as well as raw materials for the study and manufacture of a nano-sized biostructure.

A representative method of applying nanoparticles in a biomedical field is to employ the nanoparticles as a fluorescent probe for labeling cells or biomolecules. In order to employ the nanoparticles as a fluorescent probe, the surface of said nanoparticle has to be introduced with functional groups capable of conjugating with a target biomolecule.

Since the nanoparticles introduced with functional groups can bind to biomolecules such as DNA, it can have various applications in the biochemical field such as gel electrophoresis, polymerase chain reaction (PCR) and the like, thereby rapidly processing and analyzing huge bioinformations. For example, a probe can be prepared that is capable of recognizing biomolecules by introducing functional groups into the surface of said nanoparticles, wherein the biomolecules are exemplified by antigens, single DNAs and streptavidin used in an antigen-antibody reaction, a comprehensive DNA system and a streptavidin-biotin system, respectively.

Organic phosphor molecules such as an organic dye have been most widely used for the single- or multiple-detection of biomolecules. Thus, the labeling of biomolecules using said phosphors such as an organic dye is the most useful method in the study of bioscience.

However, since the organic phosphors have a narrow excitation spectrum while their emission spectrum is very wide to thereby induce a spectrum overlapping, they may be disadvantageous in that they are impossible to use for the multiple-detection of biomolecules and there is a need for an additional reaction for labeling a target biomolecule. In spite of these disadvantages, there has been a gradual increase in the demand of developing a device for detecting various dye colors by using multiple dyes in the study of bioscience.

Contrast to the organic phosphors, semiconductor nanoparticles, which are known as quantum dots, have been suggested as inorganic phosphors capable of overcoming said problems of the organic phosphors. The semiconductor nanoparticles, which exhibit a high chemical stability, are free to select an excitation wavelength, and are capable of labeling biomolecules with several types of colors having different wavelengths obtained from a single material by regulating the size of said nanoparticles. Further, since the semiconductor nanoparticles are more stable for a prolonged amount of time and show a lower level of photo-bleaching than the organic phosphors, they can be used as a fluorescent probe for observing cell imaging of a target cell or for recognizing viable cells such as cancer cells to thereby facilitate cancer diagnosis.

Since CdSe/ZnS semiconductor nanoparticles, which are known as a type of inorganic phosphor, are prepared in a trioctyl phosphine/trioctyl phosphine oxide (TOP/TOPD) organic solvent, their surfaces are coated with TOP/TOPD. Thus, they can be dispersed in numerous types of organic solvents. Further, TOP/TOPD on the surface of the nanoparticle can be replaced by a molecule having functional groups, which results in endowing a high dispersibility in water.

However, in case of introducing functional groups into the surface of CdSe/ZnS nanoparticle, for example, by treating with a silica (SiO₂) thin layer (Gerion et al., J Phys. Chem. 105(37): 8861-8871, 2001), the nanoparticles show stable photoluminescence (PL) in water for a long time. However, there have been problems of low quantum efficiency, complicated preparation process, significantly prolonged time for preparation, extremely low production yield and the like.

To overcome these problems, there has been proposed a method of introducing functional groups into the surface of CdSe/ZnS nanoparticle by using a molecule having two functional groups such as mercaptoacetic acid (Mirkin et al., J Am. Chem. Soc. 121: 8122-8123, 1999). However, said method has problems in that the functional groups become separated from the surface of CdSe/ZnS nanoparticle or the nanoparticles become precipitated due to the self-assembly between them according to the time course. Further, it has been recently reported that when ultraviolet rays are irradiated to a ZnS layer of said CdSe nanoparticle surface, sulfur-relating free radicals (generated while being oxidized therefrom) may damage the biomolecules such as DNA (Green at al., Chem. Comm. 121: 121-123, 2005). In addition, since cadmium is a harmful material causing Itai-Itai disease, it is not suited for in vivo application. Therefore, it is very difficult to apply II-VI family nanoparticles having a core-shell structure such as CdSe/ZnS to biomolecules.

Silicon nanoparticles have been proposed as semiconductor nanoparticles capable of overcoming such problems of said II-VI family nanoparticles having a core-shell structure.

To prepare the silicon nanoparticles, several methods have been employed for treating a Si/SiO₂ multiple thin layer with heat or etching a silicon substrate electrochemically (Zacharias et al., Appl. Phys. Lett. 80: 661-663, 2002; Nayfeh et al., Appl. Phys. Lett. 80: 841-843, 2002). However, said methods are disadvantageous since it is very difficult to prepare the silicon nanoparticles showing a quantum-size effect and to introduce functional groups into the surface thereof due to the oxidation of the surface into SiO₂.

### SUMMARY OF THE INVENTION

Accordingly, a primary object of the present invention is to provide a method of preparing biocompatible silicon nanoparticles, which can easily mass-produce the silicon nanoparticles showing high biocompatibility and dispersion stability in an aqueous solution, thereby being useful as a fluorescent probe for labeling biomolecules.

In accordance with one aspect of the present invention, there is provided a method of preparing silicon nanoparticles comprising the steps of:

i) obtaining a silicon nanoparticle colloid by ultrasonic treatment of a Si-containing zintle salt in diethylene glycol diethyl ether (DGDE); and

ii) adding a halogenated hydrogen solution to the silicon nanoparticle colloid obtained in step (i) and stirring the mixture.

In accordance with another aspect of the present invention, there are provided silicone nanoparticles prepared according to said method, the surfaces of which are modified with hydroxyl groups.

### BRIEF DESCRIPTION OF DRAWINGS

The above and other objects and features of the instant invention will become apparent from the following description of preferred embodiments taken in conjunction with the accompanying drawings, in which:

FIG. 1 is a transmission electron microscopy (TEM) photograph of a silicon nanoparticle colloid obtained in Example 1 of the present invention;

FIG. 2 is a graph illustrating the result of a particle distribution analysis of a silicon nanoparticle colloid obtained in Example 1 of the present invention;

FIG. 3 is a Fourier transform infrared rays (FT-IR) spectrum of a silicon nanoparticles prepared in Example 1 of the present invention, the surfaces of which are modified with hydroxyl groups; and

FIG. 4 is a photoluminescence spectrum of a silicon nanoparticle colloid obtained in Example 1 of the present invention.

### DETAILED DESCRIPTION OF THE PREFERRED EMBODIMENTS

The present invention is characterized by preparing biocompatible silicon nanoparticles, which can be used in the labeling of biomolecules. Said method comprises the steps of obtaining a silicon nanoparticle colloid through a wet chemical process by using a Si-containing zintle salt as a precursor, and treating the silicon nanoparticle colloid with a halogenated hydrogen solution.

In accordance with the method of the present invention, it is possible to prepare silicon nanoparticles in a high yield under the mild conditions of atmospheric temperature and pressure. Further, it is possible to easily introduce polar functional groups capable of binding to biomolecules such as hydroxyl groups onto the surfaces thereof. Thus, the mass-production of biocompatible silicon nanoparticles showing high dispersion stability in an aqueous solution can be greatly facilitated.

The process of preparing biocompatible silicon nanoparticles in accordance with the present invention is described in detail, as follows.

First, a Si-containing zintle salt and DGDE are added to a container under inert gas atmosphere such as argon, helium, nitrogen and the like, and the mixture is subjected to ultrasonic irradiation under atmospheric temperature and pressure for a minute to 10 hours so as to obtain a silicon nanoparticle colloid. Here, it is preferable to employ the container that: has a closed system for preventing a solvent from leaking during the ultrasonic treatment; can exchange the inert gas for regulating its inside atmosphere; and is manufactured to be installed with an ultrasonic probe and a thermocouple.

In the method of the present invention, it is preferable to employ the Si-containing zintle salt and DGDE at the weight ratio ranging from 1:10 to 1:100,000 and irradiate ultrasonic waves having an electric power ranging from 10 to 2,000 W and a frequency ranging from 1 to 100 kHz. Further, in order to more efficiently perform the ultrasonic treatment by increasing the density of ultrasonic energy during the same procedure, it is possible to use a ultrasonic probe having a diameter ranging from 0.1 to 20 mm.

Representative examples of the Si-containing zintle salt employable in the present invention include, but are not limited to, lithium silicide (LiSi), sodium silicide (NaSi), potassium silicide (KSi), magnesium silicide (MgₓSi, wherein x is 0.5 ≦x≦2), calcium silicide (CaₓSi, wherein x is 0.5 ≦x≦2) and the like. The Si-containing zintle salts can be commercially obtained or personally prepared according to a conventional method, which comprises the steps of: adding a suitable metal and silicon powders to a platinum tube; sealing the tube by putting in a quartz ample; and reacting the mixture at 500 to 1200° C. for a day to 10 days.

Subsequently, the biocompatible silicon nanoparticles in accordance with the method of the present invention can be prepared by introducing hydroxyl groups into the surface of the silicon nanoparticle obtained above. In particular, a halogenated hydrogen aqueous solution such as HF, HCl, HBr, HI and the like is added to the silicon nanoparticle colloid obtained above, and the mixture is stirred for a minute to 10 hours. Then, the residual solvent and excessive halogenated hydrogen are removed by vacuum evaporation, and DGDE solvent is further added thereto. Finally, the resulting mixture is subjected to centrifugation to thereby obtain the silicone nanoparticles modified with hydroxyl groups on the surfaces thereof in a high yield ranging from about 1 to 60%. At this time, a byproduct salt, which is generated by reacting halide anions of the halogenated hydrogen with Zintl salts, can be removed by filtering with a filter having a pore size ranging from 0.2 to 2 μm.

In the above step, it is preferable that the concentration of the halogenated hydrogen aqueous solution is in the range from 1 to 35 weight%, and the amount thereof added is in the range from 0.01 to 1 weight % based on the weight of the silicon nanoparticle colloid.

The silicon nanoparticle prepared according to the method of the present invention is spherical, the size of which is in the range from 1 to 5 nm. Further, since the surface of said silicon nanoparticle is modified with soluble functional groups such as hydroxyl groups, they can be homogeneously dispersed in an aqueous solution and are capable of conjugating with biomolecules having functional groups. In addition, the silicon nanoparticles of the present invention do not contain any harmful substance such as sulfur (S). Thus, they can be effectively used as a biocompatible fluorescent probe for labeling cells or biomolecules.

According to the above-described method of the present invention using Si-containing zintle salt as a precursor for the preparation of silicon nanoparticles and treating it with ultrasonic waves in DGDE, the silicon nanoparticles can be prepared under the mild condition of atmospheric temperature and pressure in a high yield while hydroxyl groups can be introduced on the surfaces thereof with easy, thereby facilitating the mass-production of biocompatible silicon nanoparticles. Further, since the silicon nanoparticles prepared according to the method of the present invention, which are modified with hydroxyl groups on the surfaces thereof, do not contain any harmful material such as sulfur (S) and maintain a dispersion stability in an aqueous solution for a long time, they can be effectively used as a biophosphor for cancer diagnosis and cell imaging.

The present invention will now be described in detail with reference to the following examples, which are not intended to limit the scope of the present invention.

### Example 1

After 2 g of metal sodium (purity: 99.9%) and 3 g of silicon powders (purity: 99.999%, Alfa) were added to a platinum tube, the tube was sealed by putting in a quartz ample and reacted at 90° C. for a day so as to obtain 4 g of sodium silicide.

A hundred ng of sodium silicide obtained above and 50 ml of DGDE were added to a 100 ml-volumetric glass conical flask equipped with a ultrasonic probe having a diameter of 10 mm under argon atmosphere (purity: 99.999%, Alfa). Further, ultrasonic waves having an electric power of 350 W and a frequency of 20 kHz were irradiated thereto at room temperature for 1 hour to obtain a dark brown silicon nanoparticle colloid.

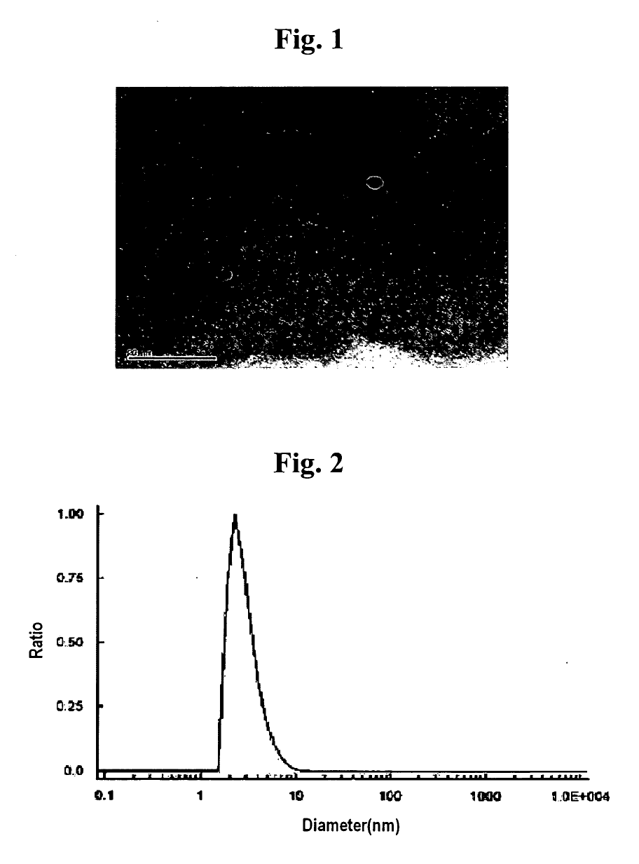

As a result of observing the silicon nanoparticle colloid thus obtained with a transmission electron microscope (TEM), it was found that the silicon nanoparticle colloid is comprised of spherical nanoparticles having an average particle size ranging from 1 to 5 nm (see FIG. 1). Further, the analysis for a particle distribution of the silicon nanoparticle colloid dispersed in a solution through a dynamic light scattering method (DLS) showed that the silicon nanoparticles of the present invention are quantum dots, which exhibit a superior particle distribution pattern and have a quantum-size effect having an average particle size of about 2.7 nm (see FIG. 2). In addition, the silicon nanoparticle colloid was analyzed by irradiating a He-Cd laser (pumping wavelength: 325 nm) and a photoluminescence spectrum obtained therefrom is shown in FIG. 4. As illustrated in FIG. 4, the silicon nanoparticles prepared according to the present invention had photoluminescence characteristics that their maximum central wavelength is about 430 nm and their full width at half maximum is about 130 nm.

Subsequently, the silicon nanoparicle colloid was cooled down to room temperature, 0.05 ml of a HCl aqueous solution having a concentration of 32 weight % was added thereto, and then the mixture was stirred. At this time, as soon as the HCl aqueous solution was mixed with the silicon nanoparticle colloid, the mixture's color was changed from dark brown to light yellow and some precipitates were formed. After stirring the mixture for about 1 hour, the residual solvent and excessive HCl were removed through vacuum evaporation. About 50 ml of DGDE was further added thereto, and the resulting mixture was subjected to centrifugation to separate a supernatant from the precipitates, thereby obtaining silicon nanoparticles modified with hydroxyl groups on the surfaces thereof (yield: 60%). A byproduct salt separated as the precipitates was removed by filtrating using a filter having a pore size of 0.2 μm.

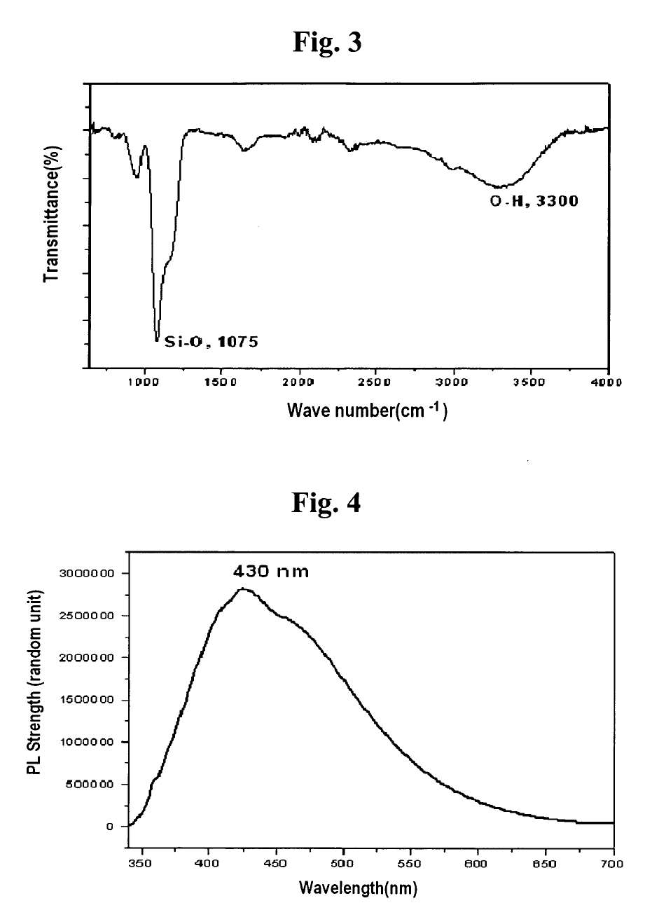

The result of a Fourier transformed infrared (FT-IR) spectrum analysis of the silicon nanoparticles prepared above, the surfaces of which are modified with hydroxyl groups, is shown in FIG. 3. As can be seen from FIG. 3, a peak corresponding to the binding between the silicon molecule and an oxygen atom of the hydroxyl group was detected at 1100 cm⁻¹ and a peak corresponding to the binding between oxygen and hydrogen atoms of the hydroxyl group was detected at 3300 cm⁻¹. From these results, it was confirmed that the hydroxyl groups are successfully introduced into the surface of the silicon nanoparticle as a polar functional group.

While the present invention has been described and illustrated with respect to a preferred embodiment of the invention, it will be apparent to those skilled in the art that variations and modifications are possible without deviating from the broad principles and teachings of the present invention, which should be limited solely by the scope of the claims appended hereto.

What is claimed is:

1. A method of preparing biocompatible silicon nanoparticles, the method comprising the steps of:
i) obtaining a silicon nanoparticle colloid by ultrasonic treatment of a Si-containing zintle salt in diethylene glycol diethyl ether (DGDE); and
ii) adding a halogenated hydrogen solution to the silicon nanoparticle colloid obtained in step (i) and stirring the mixture.

2. The method of claim 1, wherein the Si-containing zintle salt is selected from the group consisting of lithium silicide (LiSi), sodium silicide (NaSi), potassium silicide (KSi), magnesium silicide (MgₓSi, wherein x is 0.5≦x≦2) and calcium silicide (CaₓSi, wherein x is 0.5≦x≦2).

3. The method of claim 1, wherein the ultrasonic treatment is performed by irradiating ultrasonic waves having an electric power ranging from 10 to 2000 W and a frequency ranging from 1 to 100 kHz at room temperature for a minute to 10 hours.

4. The method of claim 1, wherein the ultrasonic treatment is performed by using a ultrasonic probe having a diameter ranging from 1 to 20 mm.

5. The method of claim 1, wherein the halogenated hydrogen is selected from the group consisting of HF, HCI, HBr and HI.

6. The method of claim 1, wherein the concentration of the halogenated hydrogen solution ranges from 1 to 35%.

7. A biocompatible silicon nanoparticle prepared according to the method of any one of claims 1 to 6, a surface of which is modified with hydroxyl groups.
